(19) United States
(12) Patent Application Publication
(10) Pub. No.: US 2012/0046102 A1
(43) Pub. Date: Feb. 23, 2012

(54) METHOD AND SYSTEM FOR FACILITATING ELECTRONIC COMMUNICATIONS WITH CHILDREN

(76) Inventor: Michael Leonard Tully, Los Angeles, CA (US)

(21) Appl. No.: 12/858,344

(22) Filed: Aug. 17, 2010

(51) Int. Cl. G06F 17/00

(52) U.S. Cl. 463/31; 463/40; 463/35; 463/43

(57) ABSTRACT

A system for enabling a child's play activity with a toy to be translated into a pre-defined communication to a secondary user. The system comprises one or more toys or electronic devices that may be equipped with unique identifiers. Upon activating a switch or sensor on a particular toy or electronic device, a unique identifier for the particular toy may be transmitted through a wired or wireless connection to a receiving electronic device. The receiving electronic device includes software that associates a received unique identifier with a pre-defined message and one or more secondary users. The software application transmits the pre-defined message to the secondary user(s) via an electronic message.

### FIELD OF THE INVENTION

The invention relates to a method and system that allows infants and/or children to send and/or receive communications through the use of play toys and electronic devices.

### BACKGROUND OF THE INVENTION

To date, many devices have been proposed to amuse and facilitate the development and education of infants, toddlers, and young children, collectively referred to as children throughout this patent application. Such devices may provide a combination of musical, verbal, and imagery activities to help children develop important skills and aptitude as they grow. For example, sounds, music, recordings, and/or images may be provided as a result of a child manipulating a toy by pressing buttons, pulling strings, biting, squeezing, or simply moving the toy about.

Some toy devices may have different shapes and colors that capture the attention of the child. Research has indicated that some children are thought to associate different colors and shapes with different moods and feelings. For example, interactions with the color yellow may indicate the child is feeling irritated or cranky, green and blue may indicate the child is calm and peaceful, orange may indicate the child is happy and loving, and red may indicate the child is excited and rambunctious.

Some toys may also be pre-programmed to play specific tones, music, or recordings based on how a child interacts with the toys. For example, some children's educational devices allow different pictures identifiable by a child (e.g., family photos, animals, etc.) to be inserted into buttons. When a child presses these buttons, a pre-recorded sound or message can be played to the child so the child may associate the sound with the picture. For example, a mother's voice message may play when her picture is pressed or a corresponding sound of an animal may play when the animal's picture is pressed.

With these toys, a child's interactions are only between the child and the toy. Such interactions may represent that the child is recalling a particular family member or is in a particular mood. In some instances, it may be desirable for these interactions to be observed by those who care for the child.

For example, a child may be gifted toys by family, friends, and acquaintances. Once these toys are left for the child, the parents or a gift giver who may wish to know if the child is recalling him through association with the toy or whether the child is in a certain mood through the child's interactions with the particular colors or shapes. Therefore, there is a need for a child's interactions to be instantly communicated to persons who wish to keep track of and observe the child's behavior as he or she interacts with various toys.

### SUMMARY OF THE INVENTION

A child's interaction with his or her toys is generally observed visually. However, it may be desirable to capture how the child interacts with the toy and to send instant communications regarding the child's activities with the toy to one or more followers (e.g. parents, family, friends, etc.) who may or may not be in the presence of the child. In one embodiment of the present invention, a system is provided which enables various interactions with a toy (e.g., pressing buttons, pulling strings, biting, squeezing, movement) by a primary user (e.g., a child) to trigger an instant communication to an observing or secondary party (e.g. parents, relatives, and friends).

Some embodiments of the invention provide toys equipped with sensors, buttons, and/or switches that, when activated by a primary user, cause a signal to be transmitted to an electronic device (e.g., a computer). In some embodiments, these signals are translated by a software program into pre-determined messages that may be instantly communicated to a secondary user. Other embodiments of the present invention provide a device that keeps a log of primary user activity stored on a memory within the device. In one aspect of the invention, the log can be downloaded to a secondary electronic device which may trigger automatic messages to be sent to secondary users.

Another embodiment of the present invention provides a touch-screen device that, when simply manipulated by a primary user, triggers instant communication to a secondary user. Some embodiments of the invention may also provide means for a secondary user to send messages (e.g., electronic signals, sounds, messages, photos, video) to the touch-screen device.

### BRIEF DESCRIPTION OF THE DRAWINGS

The novel features of the invention are set forth in the appended claims. However, for purpose of explanation, several embodiments of the invention are set forth in the following figures.

FIG. 1 illustrates one embodiment of a system for communicating a primary user's activity with a toy to a secondary user's electronic device.

FIG. 2 illustrates a process for configuring one embodiment of the system that incorporates a wireless network.

FIG. 3 illustrates a process for configuring one embodiment of the system that incorporates radio frequency identifications tags.

FIG. 4 illustrates a process for generating a message for a secondary user.

FIG. 5 conceptually illustrates one embodiment of a software application used in the present system.

FIG. 6 conceptually illustrates a computer system with which some embodiments of the invention are implemented.

### DETAILED DESCRIPTION OF THE INVENTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

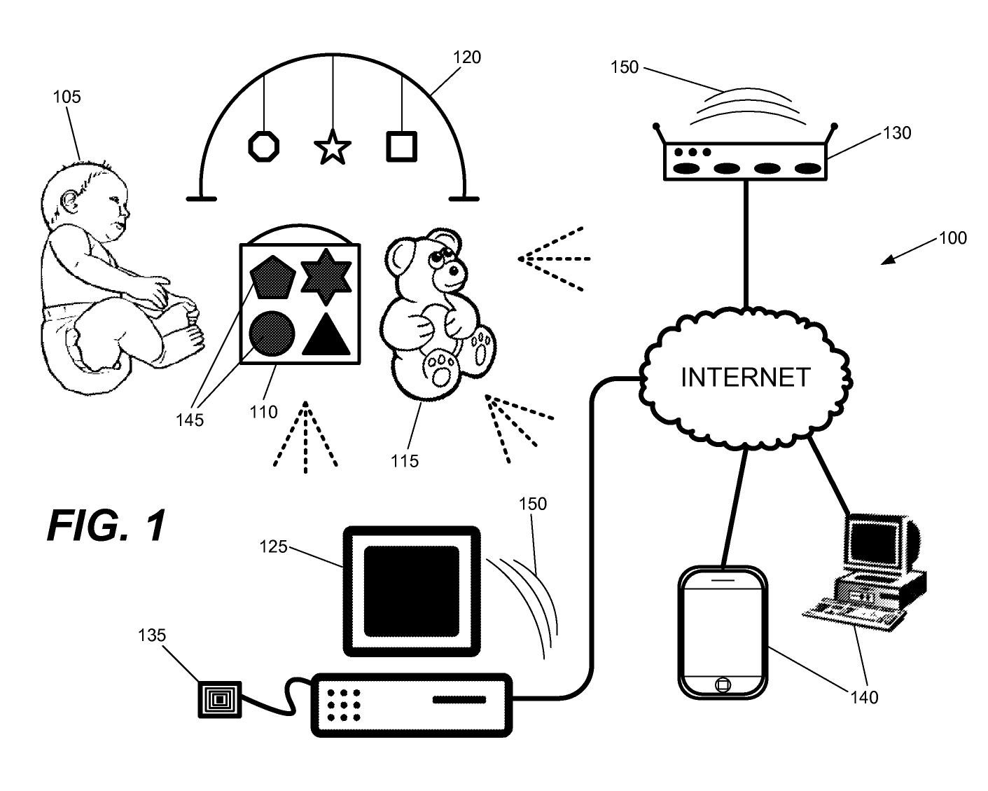

For a children's toy, some embodiments of the invention provide a primary device or devices which a primary user (e.g., infants, toddlers, young children, etc.) manipulates for his or her amusement. When certain interactive elements are triggered by the primary user, electronic signals may be transmitted to instant communication software that delivers electronic signals, content, and/or messages to a secondary user (e.g., parents, family members, friends, etc.) reflecting the primary user's activity. One example of such a system is illustrated in FIG. 1.

FIG. 1 illustrates a child messenger system 100 which facilitates communications between a primary user and a secondary user by forwarding messages regarding the primary user's activity with a particular toy or device. Specifically, FIG. 1 illustrates an infant 105 (i.e. a primary user), a push button toy device 110, a plush toy 115 (e.g. stuffed animals, teddy bears), a crib mobile 120, a computer 125, a wireless router 130, a radio frequency identification (RFID) reader 135, secondary electronic devices 140, buttons 145 of the toy device 110, and a wireless network 150.

Although many elements are illustrated in FIG. 1, the system 100 may not require every element to operate as intended. The following sections will describe i) various toy devices that may be used within the system, ii) communications methods within the system, iii) processes for configuring the system, iv) a process for delivering instant communications messages using the system, v) a description of a software modules used to implement some embodiments of the system, and vi) a description of a computer system which may implement some embodiments of the invention.

### Toy Devices

Some embodiments of the present system 100 may include a single toy or electronic device which may trigger an instant communication to a secondary user. As illustrated in FIG. 1, some embodiments may utilize a variety of different toys and/or electronic devices that may be interconnected within the same system for the amusement of a child 105. For example, in the case of a household or nursery with multiple infants, multiple devices 110, 115, and 120 may be connected to the same system. Each device may include different trigger mechanisms (e.g., switches, button actuators, sensing elements, motion sensors, pull strings, etc.) that cause the device to transmit signals to a computer 125, a RFID reader 135, and/or secondary electronic devices 140 (e.g., a cell phone, computer, PDA, etc.).

As illustrated in FIG. 1, a multi-button device 110 may be one toy that is active in the system 100. In some embodiments, the buttons 145 or other interactive elements may be spread over several devices which may be electronically and/or physically interconnected (e.g., four separate devices, each with one button apiece).

In some embodiments, a button 145 on the one or more devices may light up, vibrate, or make noise (e.g., musical tones or squeaky sounds). The buttons 145 may be made from plastic, plush, rubber/jelly, or using any combination of similar material. Buttons may also bear distinct and interchangeable graphic representations (e.g., family photos) and/or be a variety of colors and shapes (e.g., circles, triangles, crescent moons, food objects, and holiday-related icons, musical instruments, etc.).

Other than button based devices, toys and/or devices in the system 100 may include plush toys 115 (e.g., stuffed animals, dolls, etc.) and crib mobiles 120 that may include toys, rattles, or chimes attached to strings or ropes to be placed above a child. Other embodiments may include toys with a steering wheel that can rotate and be spun or revolved on a fixed axis. Furthermore, a device in the system may be a soothing teething toy, in which case a primary user might bite the device and trigger internal buttons in the process. Some embodiments may include devices that may be encased in a removable/changeable skin or made out of rubber/jelly. Such device skins may also be designed to be gender-specific. Additionally, the device may be an accessory which is able to be integrated with existing or unrelated toys and devices. Such integration may enable transmission of data and other content when a primary user manipulates the device that is integrated into the existing toy.

In another embodiment, a primary device may include a still camera. In such an embodiment, the camera may take a photo when the infant presses a button on the device or at predetermined times or intervals. These pictures may then be delivered electronically along with or separate from other content. The hardware may also include a video camera to allow for streaming video or video segments filmed in conjunction with the primary user's use of the device. For example, video clips may be automatically recorded or streamed when the primary user manipulates the device or devices. Some embodiments may incorporate a motion sensor which may trigger when the primary user moves about. This may trigger photographic or video recording or streaming. The trigger may also cause the device to record multimedia content at other predetermined times or intervals. Additionally, voice capture and/or streaming technology may allow for audio content to be recorded and/or transmitted either in conjunction with the primary user's use of the device or at other predetermined times or intervals.

In yet another embodiment, a primary device may include a video screen. The video screen may also be touch sensitive in some embodiments. Such a primary device may be capable of featuring interactive video games, showing video (both for education and entertainment purposes), and showing slide shows of photos or other images. The screen may be able to display screen savers or video content, either still, animated, or live-action, which may also be paired or synced with audio content. For example, a graphic representation of clouds may be presented together with a peaceful lullaby. If the screen is touch sensitive, virtual buttons may be available for the primary user to push. Graphic representations of such virtual buttons may also be changeable in appearance. For example, a representation of suns and rainbows may be displayed during the day while a crescent moon and sheep are displayed at night.

With the rapid technological improvements occurring, some embodiments of the present invention may be encompassed in a third-party touch screen device where the computer 125 is an integrated part of the primary device. In this embodiment, the system is a combination of the third-party touch screen device with instant communication software installed on the device. The software may be capable of displaying virtual buttons that facilitate communication between primary and secondary users in lieu of a physical toy device. Such a software embodiment will be described in greater detail below.

Some embodiments of the interactive elements in the system 100 may be programmable by a secondary user. For example, a toy which has the ability to play songs when a button is pressed or a plush toy is grasped may be programmable by a computer 125 to play a song, message, or sound that is identified by the secondary user. Such interactive elements may be programmed by connecting the electronic components of the elements to a computer 125. Using the system's software, a secondary user may assign various multimedia items to be played or displayed, depending on the type of device, on the toy or device when the child triggers the element to transmit its unique identifier. Some embodiments, such as the third party-touch screen device, may also allow a secondary user to instantly push content to the primary device through the Internet.

Some embodiments of the various toy devices may also include a battery that may be rechargeable. Other embodiments may plug into an electrical outlet, USB, or FireWire plug for powering the device. Some embodiments may also include a memory for logging a primary user's activity with the device. This log may be downloaded from the device by attaching the device to the computer 125 via a USB or FireWire plug or the log may be downloaded wirelessly if a wireless connection is available and the device possesses wireless capability. Such a log allows a secondary user to review a primary user's activity with the toy devices and the time and day at which those activities were logged. Additionally, a secondary user may also review content such as photos or video that may have been captured by the primary device as a result of a primary user manipulating the device.

In some embodiments, each button, toy, or interactive element of the system 100 is assigned a unique identifier. This unique identifier may be in the form of a media access control (MAC) address, RFID tag, or similar electronic identifying means. When a child interacts with different toys, certain actions (e.g. pressing buttons, pulling strings, kicking, biting, etc.) may trigger the element to transmit its unique identifier via a wired or wireless connection to a receiving unit such as a computer 125. As explained in further detail below, this unique identifier will assist the instant communication software in sending electronic messages to one or more secondary users.

In addition to its primary function, the device may include other features generally found on children's toys. This may include minors, night lights, sound speakers, and the capacity to glow in the dark. Furthermore, some devices may be permanently attached to a crib while others may be attachable and removable in order to be placed into or onto a stroller, booster seat, blanket, high chair, car seat, mobile, teether toy, gym, walker, entertainer, or sleeper. If removable, the particular device may attach using hook and loop fasteners, snap buttons, magnets, suction cups, and fasten-able straps. Some of the devices may also be waterproof.

The above description illustrates a variety of devices that a child can manipulate and interact with. One of ordinary skill in the art will realize that, while aspects of the invention have been described with reference to numerous specific details, the invention can be embodied in other specific forms without departing from the spirit of the invention. For example, as discussed in further detail below, any toy or device that can be manipulated by a child in order to cause a trigger or sensor to activate and transmit data my be used within the system 100 illustrated in FIG. 1.

### Communication Methods

The above sections discussed that a primary devices may connect to a designated computer 125, or to a dedicated free-standing device, on which corresponding communication software may be installed. The computer 125, or other complementary device, may act as a destination for content, receiving and interpreting signals created from the primary user manipulating the toy devices, and storing and distributing content.

When a sensor is manipulated or otherwise triggered on a toy device(s) in the system 100, content generated from the toy device(s) will register on the computer 125 or complementary device via the software program. In some embodiments, the content will automatically be sent to the computer 125 while other embodiments may allow the content to be uploaded and/or saved at a later time by connecting the primary device to the software by a wired or wireless connection.

This content may also be displayed on the computer 125 or secondary device at the same instant the content is transmitted. The complementary software may also enable the designated computer or complementary device to communicate content back to the primary device(s) and may serve as a central hub for the transmission of content in all possible directions, for example, between the toy device(s), a complementary device, and the devices of secondary users 140.

The toy devices may communicate with the communication software on a computer or central server through several different communication methods. These may include, but are not limited to, wired connections, Wireless Fidelity (WiFi), RFID technology, and Bluetooth.

In some embodiments, the interactive toy 110, 115, and 120 may connect to instant communication software and the Internet through wired connections. These wired connections may be through standard network cables, USB, or FireWire connections. Although wired connections are reliable, they may not be properly suited for an environment where infants and young children are at play.

Alternative embodiment of the system may utilize IEEE 802.11 standards for facilitating communications between the interactive toys and the system software. Toy devices that incorporate WiFi antennas may be required in a wireless network 150 using WiFi as the communications method within the system. In order to configure each device to communicate using an available WiFi connection, each toy device may need to be connected to the instant communication software by a wired connection for proper configuration. In the case of a third-party touch screen device, such a wireless connection may be configured directly from the third-party device. Implementation of the present invention on a third-party touch screen device would eliminate the need for a computer because messages generated through primary user interactions with the device may be instantly forwarded to a secondary user through the Internet because the instant communication software already resides on the third-party device.

In some embodiments, the interactive toy devices 110, 115, and 120 may include Bluetooth transmitters for communicating with the computer 125 and/or secondary electronic devices 140. The use of Bluetooth technology would also require hardware and software support for Bluetooth in the computer or secondary electronic devices. In the case of a third-party touch screen device, the device may be able to share or borrow internet access from cellular devices or other personal devices through a Bluetooth connection. Such a third-party device may be able to record and save data for later access or may communicate activity data at a later time. Furthermore, a third-party touch screen device may also be programmed to transmit data to secondary users or to merely display messages or content reflecting action of the primary user on the device in lieu of transmitting messages. Due to the power consumption of Bluetooth technology in the toy device embodiments, other toy device embodiment may utilize RFID technology.

RFID technology comprising RFID tags and one or more RFID readers 135 may also be used in the present system to facilitate communication between the interactive toys 110, 115, and 120 and a computer 125. RFID tags may be incorporated into the interactive toys 110, 115, and 120 for identifying a specific interaction when manipulated by a child. Such tags may also be integrated into existing or unrelated toys and devices enabling such toys to be integrated into the system.

Generally, two types of RFID tags exist, passive and active tags. Passive tags absorb signal from RFID readers 135 to power on the tag's internal circuitry thus allowing the tag to transmit its unique identifier. Alternatively, active RFID tags are tags that are accompanied by their own power source, usually a battery that may be replaceable or rechargeable.

In one embodiment, the present system 100 may use active RFID tags that allow tags to draw energy from an internal power source and transmit the RFID information only when triggered rather then when a particular RFID tag is in close proximity to an RFID reader 135. Such a trigger may be activated when a child manipulates the toy as discussed above. An active RFID tag may have a range of one hundreds feet or more, thus allowing the RFID reader 135 to be placed a fair distance from a child's play area. The reader 135 may be communicatively coupled to the computer 125 through a USB or FireWire connection. After receiving a unique identifier of an interactive element of the system, the reader 135 may relay the information to the instant communication software which may then transmit a pre-defined message to one or more secondary users.

### Configuring the System

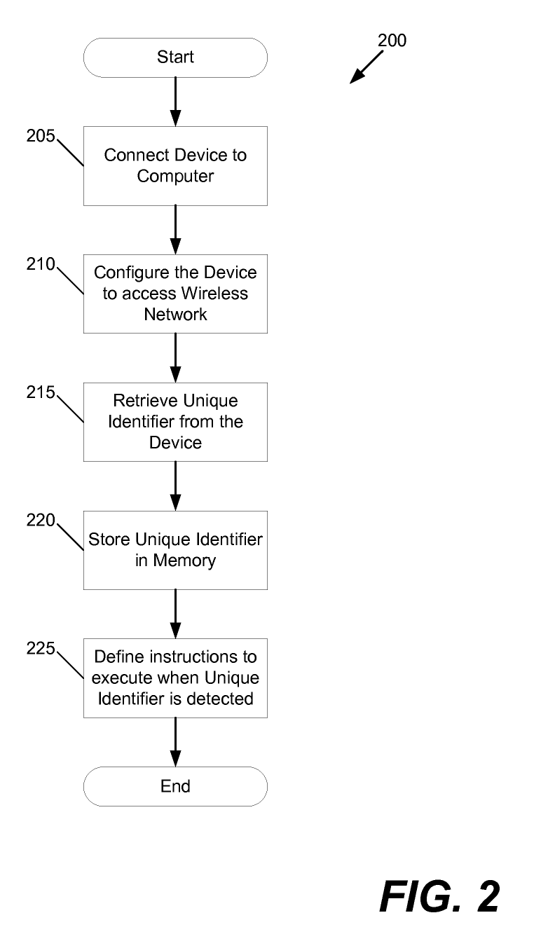

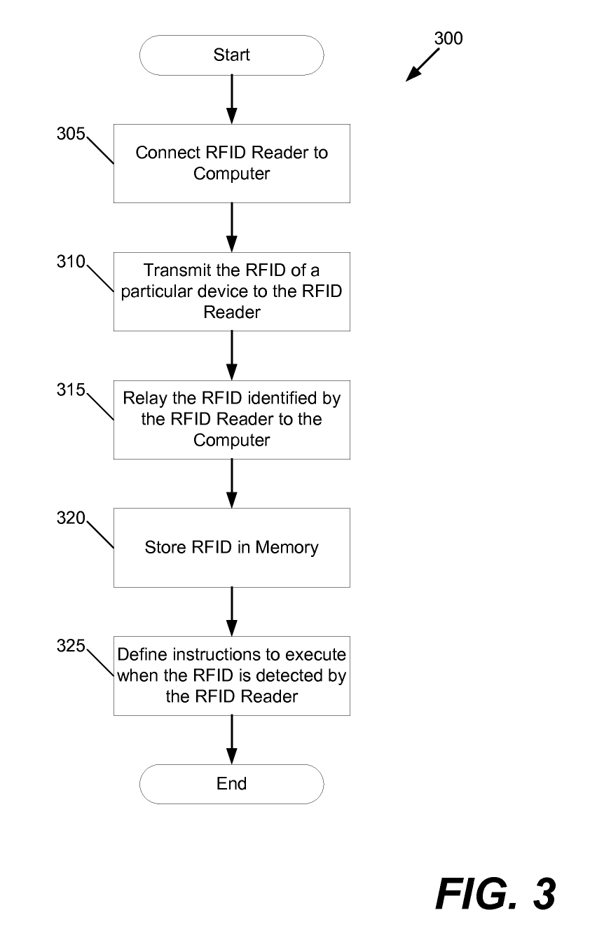

FIG. 2 and FIG. 3 conceptually illustrate processes for configuring the system 100. Specifically, FIG. 2 illustrates configuring a system that utilizes a wireless network for facilitating communications between the interactive toys and the instant communication software. In these examples, it is assumed that the instant communication software has been installed on a computer by the secondary user before proceeding.

As illustrated in FIG. 2, the process 200 begins by connecting (at 205) a primary device to the computer with a USB or FireWire cable. Once the device is connected, the instant communication software may automatically detect the hardware. Next, (at 210) the secondary user may configure the network and the device in order to allow the device to utilize the wireless network. This may require providing the network key for the electronic device and/or updating the router 130 with the MAC address of the device so the device may gain authorization to the wireless network. Other embodiments may allow the WiFi antenna of the device to roam on the network until detected and assigned as a device within the system.

Next, the process may retrieve (at 215) the unique identifier (e.g., MAC address) associated with each interactive element registered with the instant communication software. Each unique identifier is then stored (at 220) on the computer 125, for example in memory or on a hard disk drive. Finally, within the instant communication software, a secondary user may define (at 225) instructions to execute upon receiving a transmission containing a particular identifier from an interactive element in the system. These instructions may include sending an e-mail message, a text message, a voice message, a multimedia message, or a similar message to one or more secondary users who would like to follow the activity of the child and/or track the use of a specific toy or interactive element in the system. Furthermore, the instructions may dictate that one specific element of data or content is communicated in connection with a unique identifier or one of a rotating or otherwise changeable series of content. The content that is forwarded may be sent to one or more secondary users. Moreover, the instructions may also limit the number of messages forwarded to secondary users in order to prevent several messages being sent to one or more secondary users due to a primary user's continuous interaction with one specific toy or element for a prolonged period of time. Such limitation may include messages sent only at certain times, at certain intervals, or to eliminate repetitive messages received within a certain time frame.

For embodiments that may be encompassed in a third-party touch screen device, the process would not require identification of unique identifiers because interactions with the content displayed on the screen may dictate the communication to be sent rather than interactions with a particular toy or element of a toy device.

Similarly, FIG. 3 illustrates a process for configuring a system that utilizes RFID technology. Again, it is assumed the system software is already installed. The reader 135 is first connected (at 305) to a computer 125. Once the RFID reader is properly functioning and set up with the software, the secondary user may transmit (at 310) the unique identifier (i.e. RFID) of a particular toy's RFID tag by manipulating the toy or RFID device that may be incorporated into an existing toy in order to deliver power to the RFID tag thereby causing the tag to transmit its unique identifier. The RFID reader will then interpret and relay (at 315) the particular RFID information to the software running on the computer. The unique RFID signal may then be stored (at 320) on the computer in memory or on a hard disk drive. Finally, a secondary user may use the software containing the stored RFIDs to define instructions (at 325), as explained above, to execute when the RFID reader 135 receives tag data transmitted by the particular interactive element in the system.

Although the above examples illustrate specific embodiments for configuring the present system, a combination of the procedure may be used or another procedure altogether may establish a similar system without departing from the spirit or scope of the invention.

### Delivering Instant Communications

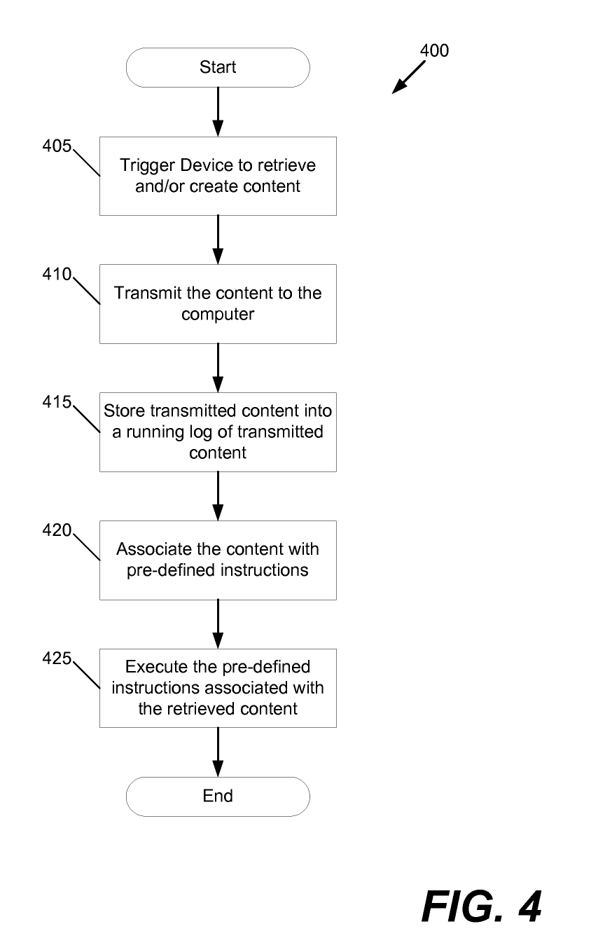

FIG. 4 illustrates a process 400 for delivering an instant communication message to a secondary user who wishes to follow the activity of a child and/or a particular interactive element in the system. The process 400 is initiated when a primary user triggers (at 405) a primary device to retrieve and/or create content (e.g., retrieve the unique identifier or RFID or record a picture or video) by playing with or manipulating the toy device. Next, content generated by the device is transmitted (at 410) to a computer which the communication software has been installed on. The content may comprise the unique identifier of the device being manipulated. The content may also include photos or video which the device captures in response to a primary user manipulating the device if the device is equipped with such functionality. This content is then logged (at 415) and stored to memory or a hard disk drive which a secondary user may access at a later time to review a complete history of activity. Such a log may also be uploaded to a dedicated website so any secondary user authorized to access the log may follow the activities of a primary user at any time over the Internet.

Once the software receives and logs the content, it will associate (at 420) the content with instructions that were pre-defined by a secondary user during the system configuration as described above. For example, the unique identifier or RFID tag transmitted in the content will be compared to the list of unique identifier and/or RFID tags stored in the system during configuration. The pre-defined instructions associated with the retrieved content (i.e. the unique identifier or RFID tag) is then executed (at 425) by the computer and specified messages and/or content may be forwarded to one or more secondary users.

Secondary users may include anyone who receives the content generated and sent by the communication software. Some secondary users may receive content on personal computing devices and/or cellular devise. Other secondary users may include those that have installed complimentary instant communication software and electronically opted to or been electronically invited to follow a specific device/user using that software. Some secondary users may be able to follow and/or retrieve content from primary users at a predetermined location on the Internet as described above.

Secondary users may also view and/or receive content from primary users via email, telephone call, MMS, SMS text message, or third party application. They may also view and/or receive content from primary users via secondary users' PDA and cellular phone applications. This may include instant messaging networks or social networking websites that may already exist or that may be created by independent parties. Messages may also be received online on networking sites which may be created specially for primary users of this device and those that wish to see and receive content the primary users and primary devices generate. Secondary users and other specially-designated users (e.g. parents and grandparents of primary users) may be able to add, amend, or make comments upon content originating from primary users, either at online locations where content originating with primary users is archived and/or displayed, or in follow-up messages transmitted back to primary users or to one or more secondary users.

Secondary users may receive content on personal computers, mobile devices, or on dedicated messenger receivers associated with the present invention. For examples, a dedicated receiver may include watches, bracelets, rings, key chains, or key chain accessories designed to receive, display, and in some embodiments send content back to the primary device. Thus, some embodiments may be designed to allow for two-way communication. That is, secondary users may be able to send signals, transmissions, photos, live streaming audio and video, recorded audio and video, or other content, back to the primary device. This content may play live on the primary device or to be saved to be played and/or displayed on the primary device upon the execution of some predetermined prompt or at some predetermined time or times.

If a two- or three-way connection between a primary device, a complementary device and the devices of secondary users may allow content to be communicated and saved onto the primary device from the complementary device and/or the devices of secondary users. An example of such content may include downloaded content (e.g, movies, TV shows, interactive games, interactive lessons, etc.), photos, voice recordings, and musical recordings. This content may be displayed on a screen, heard through speakers of the primary device, and/or expressed via light-up or noisemaking buttons or other interactive elements of the primary device.

### Overall Software Architecture

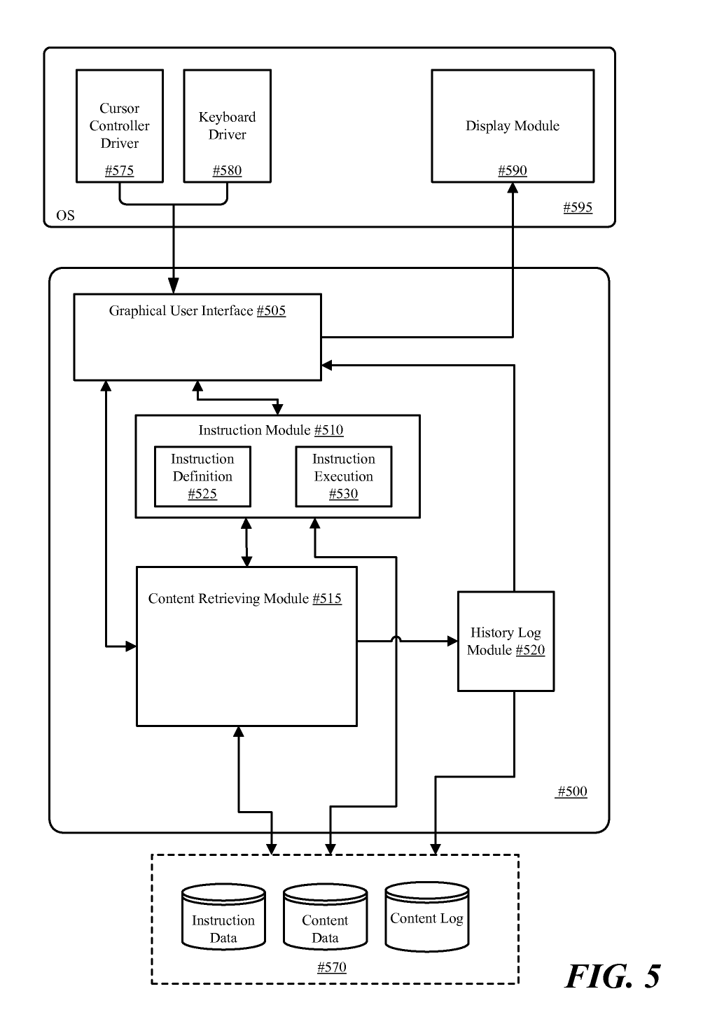

In some embodiments, the above-described operations are implemented as software running on a particular machine, such as a desktop computer, laptop, or handheld device, (or stored in a computer readable medium). FIG. 5 conceptually illustrates the software architecture of an application 500 in accordance with some embodiments. In some embodiments, the application is a stand-alone application or is integrated into another application (for instance, application 500 might be a portion of an instant communication software), while in other embodiments the application might be implemented within an operating system. Furthermore, in some embodiments, the application is provided as part of a server-based (e.g., web-based) solution. In some such embodiments, the application is provided via a thin client. That is, the application runs on a server while a user interacts with the application via a separate client machine remote from the server (e.g., via a browser on the client machine). In other such embodiments, the application is provided via a thick client. That is, the application is distributed from the server to the client machine and runs on the client machine. In still other embodiments, the components (e.g., engines, modules) illustrated in FIG. 5 are split among multiple applications. For instance, in some embodiments, one application defines the identifications of each toy or device in the system while another application allows a user to define an electronic message to generate and transmit when receiving a signal containing the identification of a particular toy or device in the system.

The application software may receive, display, and store messages and other content originating from primary devices. A primary user may push buttons on the device or devices, manipulate, or bite one of the above discussed interactive elements and in doing so, creates corresponding electronic messages to be delivered to secondary users, via the designated computer or other free-standing device on which software has previously been installed. The message may include written/typed messages, symbols, pictures, videos, songs, or other audio as dictated by the pre-defined instructions set by the secondary user. Audio may include sounds recorded on and/or streamed from the device when triggered by the primary user, or recorded ahead of time, either directly onto the device or recorded elsewhere and subsequently saved onto the device or computer for later transmission.

In the event that the primary user will be pushing or otherwise manipulating musical or squeaky buttons or other interactive elements on the primary device, a similar or identical song, noise, or series of noises may play upon transmission and/or delivery of content to the secondary user or users. In the event that photos or videos are created on the primary device, software may allow for the creation and transmission of digitally-altered backgrounds or graphic avatars instead of or in addition to graphic representations of the primary user. In some embodiments, the software may allow for automatic translation of messages and other content into different languages. In the event of two-way communication, it may also allow for the translation of messages and other content from secondary users device or devices to primary users device or devices.

As shown in FIG. 5, the application 500 includes a graphical user interface 505, an instructions module 510, a content retrieving module 515, and a history log module 520. The graphical user interface 505 provides user-interface tools (e.g., display areas, user-interface controls, user-selectable elements, etc.) that a user of the communication application 500 interacts with in order to create instructions to be executed when the application receives a transmission from a primary device.

The operating system 595 of some embodiments includes a cursor controller driver 575 for allowing the application 500 to receive data from a cursor control device, a keyboard driver 580 for allowing the application to receive data from a keyboard, and a display module 595 for processing visual data that will be supplied to a display device (e.g., a monitor).

As shown in FIG. 5, to facilitate the entry and execution of instructions, the application 500 includes an instruction module 505. In some embodiments, the instruction module 500 may include an instruction definition module 525 and an instruction execution module 530. In some embodiments, when a user inputs instructions through one of the user interface tools, the instruction definition module 525 receives and stores the instructions in the set of data storages 570. The instruction module 510 may also include an instruction execution module 530 to facilitate execution of one or more stored instructions when a transmission from a primary device calls for such an execution.

FIG. 5 also illustrates a content retrieving module 515. In some embodiments, the content retrieving module may retrieve unique identifiers and/or RFID information from primary toy devices during the configuration procedure as described above. The content retrieving module may also receive transmissions of content from primary devices after the primary devices have been configured in the system. The content may include the unique identifier and/or the RFID information of the primary device. The content may also include pictures, video, or audio content if the primary device is capable of capturing such content. The retrieved content may then me stored in the data storages 570, displayed on the display module 590 through the graphical user interface 505, and be passed to a history log module 520 which may keep a chronological history of the primary user's activities. The history log module 520 may also be stored in the data storages 570. All content stored in the data storages 570 may be accessed locally on the computer or may be accessed over the Internet if such access is granted or if the content is kept on a central server.

The above described application in an exemplary embodiment of an application that receives content transmitted by primary devices due to a primary user playing, biting, kicking, pulling, or manipulating a primary device so that the transmitter is activated. In the case of a third-party touch screen device, this application may use the same exact components. However, the content retrieving module 515 may interpret a primary user's interactions with content displayed on the touch screen as generating content that may execute a particular pre-defined instruction rather than receiving a unique identifier or RFID information from a particular primary device. Since the third-party device may be a computing device, the primary user is effectively using a computer which translates interactions by the primary user to executable instructions that may deliver pre-determined content to secondary users. The instruction module 510 may allow a secondary user to program the application 500 stored on the third-party device to display pre-determined content to the primary user when the application is running. This may include picture, audio, and video content.

For example, a secondary user may instruct the application to display large photos of family members on the screen. Upon interacting with the photos, the content retrieving module would capture the primary user's interactions and may, for example, send the primary user's father a SMS message or e-mail when the primary user interacts with his father's photograph. Furthermore, the application may be programmed to capture audio, photographs, or video of the primary user when the primary user interacts with the touch screen as specified and programmed by the secondary user. This content may then be forwarded to one or many secondary users or simply be stored in the history log as per the secondary user's instructions.

Several different embodiment of the present invention have been described in detail above. Some embodiments incorporate primary devices that a child may interact with as a play toy, while other embodiments may comprise a communication application stored on a third-party touch screen device. It should be understood that each embodiment is set out to accomplish a similar task of facilitating communications between a child and secondary users such as the child's family. It should also be understood, that the foregoing relates to exemplary embodiments of the invention and that modifications may be made without departing from the spirit and scope of the invention as set forth in the following claims.

### Computer System

Many of the above-described processes, modules, and interfaces are implemented as software processes that are specified as a set of instructions recorded on a computer readable storage medium (also referred to as “computer readable medium”, “readable storage medium”, or “machine readable medium”). When these instructions are executed by one or more computational element(s) (such as processors or other computational elements like ASICs and FPGAs), they cause the computational element(s) to perform the actions indicated in the instructions. Computer is meant in its broadest sense, and can include any electronic device with a processor. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant in its broadest sense. It can include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs when installed to operate on one or more computer systems define one or more specific machine implementations that execute and perform the operations of the software programs.

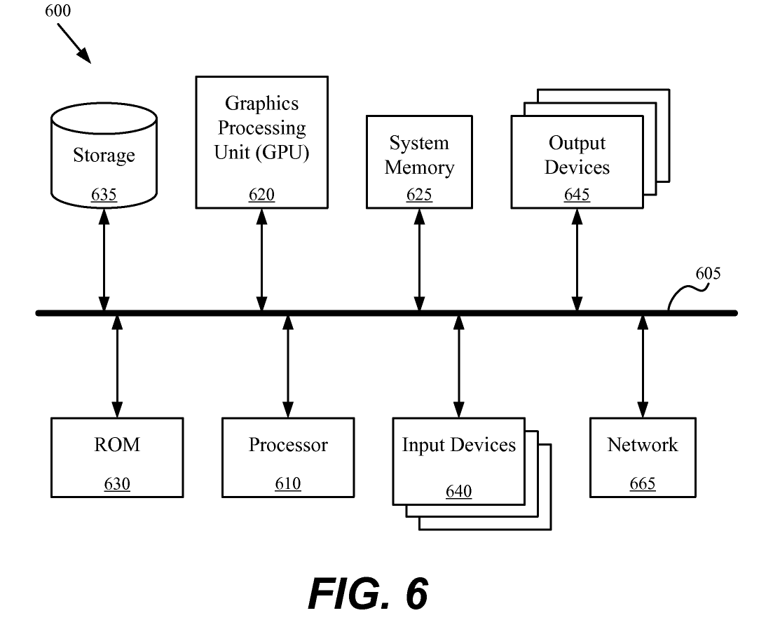

FIG. 6 conceptually illustrates a computer system 600 with which some embodiments of the invention are implemented. For example, the system described above in reference to FIG. 1 may be at least partially implemented using sets of instructions that are run on the computer system 600. As another example, the processes described in reference to FIG. 2-FIG. 4, may be at least partially implemented using sets of instructions that are run on the computer system 600.

Computer system 600 includes a bus 610, a processor 620, a system memory 630, a read-only memory (ROM) 640, a permanent storage device 650, a graphics processing unit (“GPU”) 660, input devices 670, output devices 680, and a network connection 690. The components of the computer system 600 are electronic devices that automatically perform operations based on digital and/or analog input signals. The exemplary software application shown in FIG. 05 may be at least partially implemented using sets of instructions that are run on the computer system 600 and displayed using the output devices 680.

One of ordinary skill in the art will recognize that the computer system 600 may be embodied in other specific forms without deviating from the spirit of the invention. For instance, the computer system may be implemented using various specific devices either alone or in combination. For example, a local PC may include the input devices 670 and output devices 680, while a remote PC may include the other devices 610-660, with the local PC connected to the remote PC through a network that the local PC accesses through its network connection 690 (where the remote PC is also connected to the network through a network connection).

The bus 610 collectively represents all system, peripheral, and chipset buses that communicatively connect the numerous internal devices of the computer system 600. For instance, the bus 610 communicatively connects the processor 620 with the system memory 630, the ROM 640, and the permanent storage device 650. From these various memory units, the processor 620 retrieves instructions to execute and data to process in order to execute the processes of the invention. In some embodiments, the processor comprises a Field Programmable Gate Array (FPGA), an ASIC, or various other electronic components for executing instructions. In some cases, the bus 610 may include wireless and/or optical communication pathways in addition to or in place of wired connections. For example, the input devices 670 and/or output devices 680 may be coupled to the system 600 using a wireless local area network (W-LAN) connection, Bluetooth®, or some other wireless connection protocol or system.

The ROM 640 stores static data and instructions that are needed by the processor 620 and other modules of the computer system. The permanent storage device 650, on the other hand, is a read-and-write memory device. This device is a non-volatile memory unit that stores instructions and data even when the computer system 600 is off. Some embodiments of the invention use a mass-storage device (such as a magnetic or optical disk and its corresponding disk drive) as the permanent storage device 650.

Other embodiments use a removable storage device (such as a floppy disk, flash drive, or CD-ROM) as the permanent storage device. Like the permanent storage device 650, the system memory 630 is a read-and-write memory device. However, unlike storage device 650, the system memory 630 is a volatile read-and-write memory, such as a random access memory (RAM). The system memory stores some of the instructions and data that the processor needs at runtime. In some embodiments, the sets of instructions used to implement the invention's processes are stored in the system memory 630, the permanent storage device 650, and/or the read-only memory 640. For example, the various memory units include instructions for processing multimedia items in accordance with some embodiments. From these various memory units, the processor 610 retrieves instructions to execute and data to process in order to execute the processes of some embodiments.

In addition, the bus 610 connects to the GPU 660. The GPU of some embodiments performs various graphics processing functions. These functions may include display functions, rendering, compositing, and/or other functions related to the processing or display of graphical data.

The bus 610 also connects to the input devices 670 and output devices 680. The input devices 670 enable the user to communicate information and select commands to the computer system. The input devices include alphanumeric keyboards and pointing devices (also called “cursor control devices”). The input devices also include audio input devices (e.g., microphones, MIDI musical instruments, etc.) and video input devices (e.g., video cameras, still cameras, optical scanning devices, etc.). The output devices 680 include printers, electronic display devices that display still or moving images, and electronic audio devices that play audio generated by the computer system. For instance, these display devices may display a GUI. The display devices include devices such as cathode ray tubes (“CRT”), liquid crystal displays (“LCD”), plasma display panels (“PDP”), surface-conduction electron-emitter displays (alternatively referred to as a “surface electron display” or “SED”), etc. The audio devices include a PC's sound card and speakers, a speaker on a cellular phone, a Bluetooth® earpiece, etc. Some or all of these output devices may be wirelessly or optically connected to the computer system.

Finally, as shown in FIG. 6, bus 610 also couples computer 600 to a network 690 through a network adapter (not shown). In this manner, the computer can be a part of a network of computers (such as a local area network (“LAN”), a wide area network (“WAN”), an Intranet, or a network of networks, such as the Internet. For example, the computer 600 may be coupled to a web server (network 690) so that a web browser executing on the computer 600 can interact with the web server as a user interacts with a GUI that operates in the web browser.

As mentioned above, the computer system 600 may include electronic components, such as microprocessors, storage and memory that store computer program instructions in one or more of a variety of different computer-readable media (alternatively referred to as computer-readable storage media, machine-readable media, machine-readable storage media, readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ZIP® disks, read-only and recordable blu-ray discs, ultra density optical discs, any other optical or magnetic media, and floppy disks. The computer-readable media may store a computer program that is executable by at least one processor and includes sets of instructions for performing various operations. Examples of hardware devices configured to store and execute sets of instructions include, but are not limited to application specific integrated circuits (ASICs), field programmable gate arrays (FPGA), programmable logic devices (PLDs), ROM, and RAM devices. Examples of computer programs or computer code include machine code, such as produced by a compiler, and files including higher-level code that are executed by a computer, an electronic component, or a microprocessor using an interpreter.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals. It should be recognized by one of ordinary skill in the art that any or all of the components of computer system 600 may be used in conjunction with the invention. Moreover, one of ordinary skill in the art will appreciate that any other system configuration may also be used in conjunction with the invention or components of the invention.

The present application describes a graphical user interface that provides users with numerous ways to perform different sets of operations and functionalities. In some embodiments, these operations and functionalities are performed based on different commands that are received from users through different input devices (e.g., keyboard, trackpad, touchpad, mouse, etc). For example, the present application describes the use of a cursor in the graphical user interface to control (e.g., select, move) user-interface elements in the graphical user interface. However, in some embodiments, these user-interface elements in the graphical user interface can also be controlled or manipulated through other control, such as touch control. In some embodiments, touch control is implemented through an input device that can detect the presence and location of touch on a display of the device. An example of such a device is a touch screen device. In some embodiments, with touch control, a user can directly manipulate user-interface elements by interacting with the graphical user interface that is displayed on the display of the touch screen device. For instance, a user can select a particular user-selectable element in the graphical user interface by simply touching that particular user-selectable element on the display of the touch screen device. As such, when touch control is utilized, a cursor may not even be provided for enabling selection of a user-selectable element of a graphical user interface in some embodiments. However, when a cursor is provided in a graphical user interface, touch control can be used to control the cursor in some embodiments.

While the invention has been described with reference to numerous specific details, one of ordinary skill in the art will recognize that the invention can be embodied in other specific forms (i.e., different embodiments may implement or perform different operations) without departing from the spirit of the invention. One of ordinary skill in the art would also recognize that some embodiments may divide a particular module into multiple modules. In addition, although the examples given above may discuss accessing the system using a particular device (e.g., a PC), one of ordinary skill will recognize that a user could access the system using alternative devices (e.g., a cellular phone, PDA, smartphone, BlackBerry®, or other device).

One of ordinary skill in the art will realize that, while the invention has been described with reference to numerous specific details, the invention can be embodied in other specific forms without departing from the spirit of the invention. One of ordinary skill in the art would understand that the invention is not to be limited by the foregoing illustrative details, but rather is to be defined by the appended claims.

What is claimed is:

1. A system for facilitating communications between a primary user and secondary users, the system comprising:
at least one toy device, wherein the toy device comprises at least one sensing element and at least one transmitter for transmitting content generated by the toy device when the sensing element is triggered by the primary user;
a receiver for receiving the transmitted content; and
a processor for processing the content from the receiver and formulating at least one pre-determined electronic message to be transmitted to at least one secondary user.

2. The system of claim 1, wherein the content comprises a unique identifier for the toy device.

3. The system of claim 2, wherein the unique identifier is one of a MAC address and a radio frequency identification associated with the toy device.

4. The system of claim 1, wherein the toy device further comprises a camera.

5. The system of claim 4, wherein the content comprises a still photo or video of a pre-determined length that is captured when the primary user triggers the sensing element associated with the camera.

6. The system of claim 1, wherein the toy device further comprises a microphone.

7. The system of claim 6, wherein the content comprises an audio recording that is captured when the primary user triggers the sensing element associated with the microphone.

8. The system of claim 1, wherein the toy device may be programmable to display graphical content or play audio.

9. The system of claim 1, wherein the content is transmitted to the receiver over one of a wired or wireless connection.

10. The system of claim 9, wherein the wireless connection is a WiFi connection.

11. The system of claim 9, wherein the wireless connection is a radio frequency connection using radio frequency identification (RFID) technology.

12. The system of claim 1, wherein the electronic message is a pre-determined message defined by the secondary user and based on the transmitted content.

13. The system of claim 1, wherein the electronic message is one of an electronic mail, SMS message, MMS message, electronic posting on the Internet, and a record in an activity history log.

14. A computer readable medium storing a computer program which when executed by at least one processor facilitates communications between primary and secondary users, the computer program comprising sets of instructions for:
receiving content transmitted from at least one toy device, wherein the content indicates activity with a particular interactive element of the toy device;
identifying at least one pre-determined electronic message based on the received content; and
transmitting the electronic message to at least one secondary user and an activity history log.

15. The computer-readable medium of claim 14 further comprising a set of instructions for defining at least one electronic message to be forwarded to a secondary user based on the received content.

16. The computer-readable medium of claim 14 further comprising a set of instructions for displaying the electronic message associated with the received content on the Internet.

17. The computer-readable medium of claim 14 further comprising a set of instruction for configuring the toy device over a wired or wireless network.

18. A computer readable medium storing a computer program which when executed by at least one processor facilitates communications between primary and secondary users, the computer program comprising sets of instructions for:
defining at least one electronic messages to transmit based upon primary user inputs;
displaying pre-determined multimedia content to the primary user;
receiving input from the primary user using a touch sensitive device;
associating said input with at least one electronic message; and
transmitting said electronic message associated with the received input to at least one secondary user.

19. The computer-readable medium of claim 18, wherein the electronic message comprises audio and video content that is displayed on a display device based on the received input.

20. The computer-readable medium of claim 18 further comprising capturing at least one of audio, picture, or video content based on the received input from the primary user.
